(19) United States
(12) Patent Application Publication
(10) Pub. No.: US 2011/0276624 A1
(43) Pub. Date: Nov. 10, 2011

(54) CONVERGED COMMUNICATION WITH WEB 2.0 BASED SCREEN TRIGGERS

(76) Inventors: Haseeb Akhtar, Garland, TX (US); Vishwamitra Nandlall, McKinney, TX (US)

(21) Appl. No.: 12/897,898

(22) Filed: Oct. 5, 2010

Related U.S. Application Data
(60) Provisional application No. 61/332,364, filed on May 7, 2010.

(51) Int. Cl. G06F 15/16

(52) U.S. Cl. 709/203

(57) ABSTRACT

A system and a method are described herein for allowing users of a social networking web site to engage in a real time communication session by participating in a screen trigger application. The screen trigger application monitors the on-line behavior of the users while they are at the social networking web site and when conditions which have been set by the users have been met then the screen trigger application initiates a real time communication session (e.g., voice, video and multimedia) between one or more of the users.

### CLAIM BENEFIT OF PRIOR FILE U.S. APPLICATION

The present application claims the benefit of U.S. Provisional Application Ser. No. 61/332,364 filed on May 7, 2010 and entitled “Converged Communication with Web 2.0 Based Screen Triggers”. The contents of this document are hereby incorporated by reference herein.

### TECHNICAL FIELD

The present invention relates to a system and a method for allowing users of a social networking web site to engage in a real time communication session by participating in a screen trigger application. The screen trigger application monitors the on-line behavior of the users while they are at the social networking web site and when conditions which have been set by the users have been met then the screen trigger application initiates a real time communication session (e.g., voice, video and multimedia) between one or more of the users.

### BACKGROUND

The following abbreviations and notations are herewith defined, at least some of which are referred to within the following description of the prior art and the present invention.

### 4G 4th Generation

### AIN Advanced Intelligent Network

### ADQ Application Driver QoS

### CS Circuit Switch

### ECE Ericsson Composition Engine

eNB enhanced Node B

### HTTP Hyper Text Transfer Protocol

### IMS IP Multimedia Subsystem

### IP Internet Protocol

### ISDN Integrated Service Digital Network

### ISUP ISDN User Part

MM1 Interface between MS and MMSC
MM4 Interface between MMSCs

### MMSC Multimedia Messaging Service Center

### MS Mobile Station

### OTT Over The Top

### PSTN Public Switched Telephone Network

### QoS Quality of Service

### RAN Radio Access Network

### RN Radio Network

### SDP Service Delivery Platform

### SIG Services Integration Gateway

### SIP Session Initiated Protocol

### SMPP Short Message Peer to Peer

### SMS Short Message Service

### SMTP Simple Mail Transfer Protocol

### SS-7 Signaling System 7

### TR.87 Technical Report 87

### UE User Equipment

### WIN Wireless Intelligent Network

### WS Web Services

### XCAP XML Configuration Access Protocol

Social networking web sites have been gaining significant momentum and market share over the last five years. For example, the social networking web site known as Facebook currently boasts a total of 400M subscribers (February, 2010), more than doubling its subscriber base of 112M merely 14 months ago (December, 2009). The same growth can be said about the other notable social networking web sites such as Myspace, Twitter, Friendster, Badoo etc.

As more and more users choose to spend a considerable amount of their browsing time (aka ‘eye ball’ time) on social networking web sites, which accounts for about 25% of the total web page browsing as of December, 2009 and growing, the OTT (Over The Top) service providers along with some independent application developers (e.g., Facebook, Google, Myspace) now have immense revenue opportunity. They are capitalizing, quite successfully nonetheless, on this ‘eye ball’ time by pushing advertisements and various applications directly to this large base of subscribers. The telecommunication operators, on the other hand, are being left out from this value chain, especially the advertisement revenues.

Thus, a healthy convergence between the social networking and telephony communications could easily put the telecommunication operators into the value chain so they can profit from users interfacing with the social networking web sites. However, the current solutions in this area are very limited. For example, one method that exists today is a user generated click-to-call feature in which the originating user (‘the calling party’) is required to click on a hyperlink of his/her Internet browser, typically the email ID of the user (‘the called party’), to initiate a phone call. Another method that exists today is where a user can chat with their online friends over IM (Instant Messaging). Otherwise, the communications over the social networking web sites are fairly static in nature. Here are some examples.
Sharing photos and videos
Sharing public information (news articles, recipes, sports events etc.)
Exchanging comments, status, daily logs etc. on the Walls
Exchanging messages via Inbox (very similar to today's email exchange)
Creating a ‘special interest page’ to promote that specific interest
Manage a social event (e.g., announcement, invitation, RSVP etc.)

It is evident from this list that all of these activities are done in the user's own time and that none of these on-line activities will trigger any real time communication session (such as voice, video, multimedia etc.) between the users. Thus, there is a need for a system and method that can monitor on-line behavior of the users while at the social networking web site and when conditions set by the users have been met then initiate a real time communication session between one or more of the users. This need and other needs are satisfied by the present invention.

### SUMMARY

A system, a user device, a web server, a service delivery platform, and methods have been described in the independent claims of the present application. Advantageous embodiments of the system, the user device, the web server, the service delivery platform, and the methods have been described in the dependent claims.

In one aspect, the present invention provides a system for allowing users of a social networking web site to engage in a real time communication session. The system comprises: (a) a plurality of user devices, each user device downloaded a client component of a screen trigger application from the social networking web site; (b) a web server that has stored therein a server component of the screen trigger application; (c) the user devices and the web server communicate to monitor on-line behavior of users of the user devices while the users interact with the social networking web site and when conditions which have been set by the users have been met then initiate a real time communication session between the users; and (d) a service delivery platform that receives a message from the web server to establish the real time communication session between the users, authenticates the users devices, checks to determine if enough resources are available to establish the real time communication session between the users, and sends messages to establish the real time communication session between the users. The system has an advantage in that it can enable a telecommunication operator to profit from users interfacing with the social networking web sites.

In another aspect, the present invention provides a method for allowing users of a social networking web site to engage in a real time communication session. The method comprising the steps of (a) providing a screen trigger application having a client component and a server component; (b) enabling users to download into user devices the client component of the screen trigger application from the social networking web site; (c) providing the server component of the screen trigger application to a web server; and (d) enabling communications between the web server and the user devices which downloaded the client component to monitor on-line behavior of the users while the users interact with the social networking web site and when conditions which have been set by the users have been met then initiate a real time communication session between one or more of the users. The method has an advantage in that it can enable a telecommunication operator to profit from users interfacing with the social networking web sites.

In still yet another aspect, the present invention provides a user device that allows a user of a social networking web site to engage in a real time communication session with other users that also interact with the social networking web site. The user device comprises a processor; and a non-transitory memory that stores processor-executable instructions wherein the processor interfaces with the non-transitory memory and executes the processor-executable instructions to: (a) download a client component of a screen trigger application from the social networking web site; and (b) communicate with a web server that implements a server component of the screen trigger application to: (i) send an update to the server component in the web server each time there is an on-line behavior of the user that changes a state associated with the client component of the screen trigger application; (ii) receive an update from the server component in the web server to monitor on-line behavior of the other users while at the social networking web site; and (iii) receive a real time communication session request from the server component in the web server when conditions which have been set by the user and the other users have been met to initiate the real time communication session between the user and the other users. The user device has an advantage in that it can enable a telecommunication operator to profit from users interfacing with the social networking web sites.

In yet another aspect, the present invention provides a method implemented by a user device for allowing a user of a social networking web site to engage in a real time communication session with other users that also interact with the social networking web site. The method comprising the steps of: (a) downloading a client component of a screen trigger application from the social networking web site; and (b) communicating with a web server that implements a server component of the screen trigger application, wherein the communicating step further comprises: (i) sending an update to the server component in the web server each time there is an on-line behavior of the user that changes a state associated with the client component of the screen trigger application; (ii) receiving an update from the server component in the web server to monitor on-line behavior of the other users while at the social networking web site; and (iii) receiving a real time communication session request from the server component in the web server when conditions which have been set by the user and the other users have been met to initiate the real time communication session between the user and the other users. The method has an advantage in that it can enable a telecommunication operator to profit from users interfacing with the social networking web sites.

In still yet another aspect, the present invention provides a web server that allows users of a social networking web site to engage in a real time communication session. The web server comprising a processor and a non-transitory memory that stores processor-executable instructions wherein the processor interfaces with the non-transitory memory and executes the processor-executable instructions to: (a) download a server component of a screen trigger application; and (b) communicate with user devices of the users that downloaded a client component of the screen trigger application from the social networking web site to: (i) receive an update from one of the client components in the user devices when there is an on-line behavior of the corresponding one of the users that changes a state associated with the corresponding client component of the screen trigger application; (ii) send an update to the other ones of the client components in the user devices so the corresponding other users are able to monitor the on-line behavior of the one user while at the social networking web site; and (iii) send a real time communication session request to the client components in the user devices when conditions which have been set by the users have been met to initiate the real time communication session between the users. The web server has an advantage in that it can enable a telecommunication operator to profit from users interfacing with the social networking web sites.

In yet another aspect, the present invention provides a method implemented by a web server for allowing users of a social networking web site to engage in a real time communication session. The method comprising the steps of: (a) downloading a server component of a screen trigger application; and (b) communicating with user devices of the users that downloaded a client component of the screen trigger application from the social networking web site, wherein the communicating step comprises: (i) receiving an update from one of the client components in the user devices when there is an on-line behavior of the corresponding one of the users that changes a state associated with the corresponding client component of the screen trigger application; (ii) sending an update to the other ones of the client components in the user devices so the corresponding other users are able to monitor the on-line behavior of the one user while at the social networking web site; and (iii) sending a real time communication session request to the client components in the user devices when conditions which have been set by the users have been met to initiate the real time communication session between the users. The method has an advantage in that it can enable a telecommunication operator to profit from users interfacing with the social networking web sites.

In yet another aspect, the present invention provides a service delivery platform that interacts with a web server and a core network to allow users of a social networking web site to engage in a real time communication session. The service delivery platform comprising a processor and a non-transitory memory that stores processor-executable instructions wherein the processor interfaces with the non-transitory memory and executes the processor-executable instructions to: (a) receive a message from the web server to establish the real time communication session after the web server which implements a server component of a screen triggering application communicates with user devices which implement a client component of the screen trigger application that was downloaded from the social networking web site such that on-line behavior of the users of the user devices while the users interact with the social networking web site is monitored and when conditions which have been set by the users have been met then the web server initiates the message to establish the real time communication session between one or more of the users; (b) authenticate the users devices and check with the core network to determine if enough resources are available to establish the real time communication session between the one or more users; and (c) send messages to the core network to establish the real time communication session between the one or more users. The service delivery platform has an advantage in that it can enable a telecommunication operator to profit from users interfacing with the social networking web sites.

In still yet another aspect, the present invention provides a method implemented by service delivery platform that interacts with a web server and a core network to allow users of a social networking web site to engage in a real time communication session. The method comprising the steps of: (a) receiving a message from the web server to establish the real time communication session after the web server which implements a server component of a screen triggering application communicates with user devices which implement a client component of the screen trigger application that was downloaded from the social networking web site such that on-line behavior of the users of the user devices while the users interact with the social networking web site is monitored and when conditions which have been set by the users have been met then the web server initiates the message to establish the real time communication session between one or more of the users; (b) authenticating the users devices and check with the core network to determine if enough resources are available to establish the real time communication session between the one or more users; and (c) sending messages to the core network to establish the real time communication session between the one or more users. The method has an advantage in that it can enable a telecommunication operator to profit from users interfacing with the social networking web sites.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings:

FIG. 1 is a block diagram of an exemplary system for allowing users of a social networking web site to engage in a real time communication session in accordance with an embodiment of the present invention;

FIG. 2 is a flowchart illustrating the steps of an exemplary method for allowing users of a social networking web site to engage in a real time communication session in accordance with an embodiment of the present invention;

FIG. 3 is a block diagram illustrating a more detailed architectural view of the exemplary system shown in FIG. 1 in accordance with an embodiment of the present invention;

FIG. 4 is a block diagram illustrating a high level sequence of events associated with the exemplary system shown in FIG. 3 while implementing an exemplary movie review screen trigger application in accordance with an embodiment of the present invention;

FIG. 5 is a flow chart that provides further details about the exemplary movie review screen trigger application discussed with respect to FIG. 4 in accordance with an embodiment of the present invention;

FIG. 6 is a diagram that illustrates several different types of real time communication sessions that can be established between users in accordance with an embodiment of the present invention;

FIG. 7 is a block diagram illustrating an architectural view of the exemplary system that can enable two users A and B to take part in a multimedia session as shown in FIG. 6 in accordance with an embodiment of the present invention;

FIG. 8 is a block diagram illustrating an architectural view of the exemplary system that can enable two users A and B to take part in a telephony session as shown in FIG. 6 in accordance with an embodiment of the present invention; and

FIG. 9 is a block diagram illustrating an architectural view of the exemplary system that can enable two users A and B to take part in an interactive TV session as shown in FIG. 6 in accordance with an embodiment of the present invention.

### DETAILED DESCRIPTION

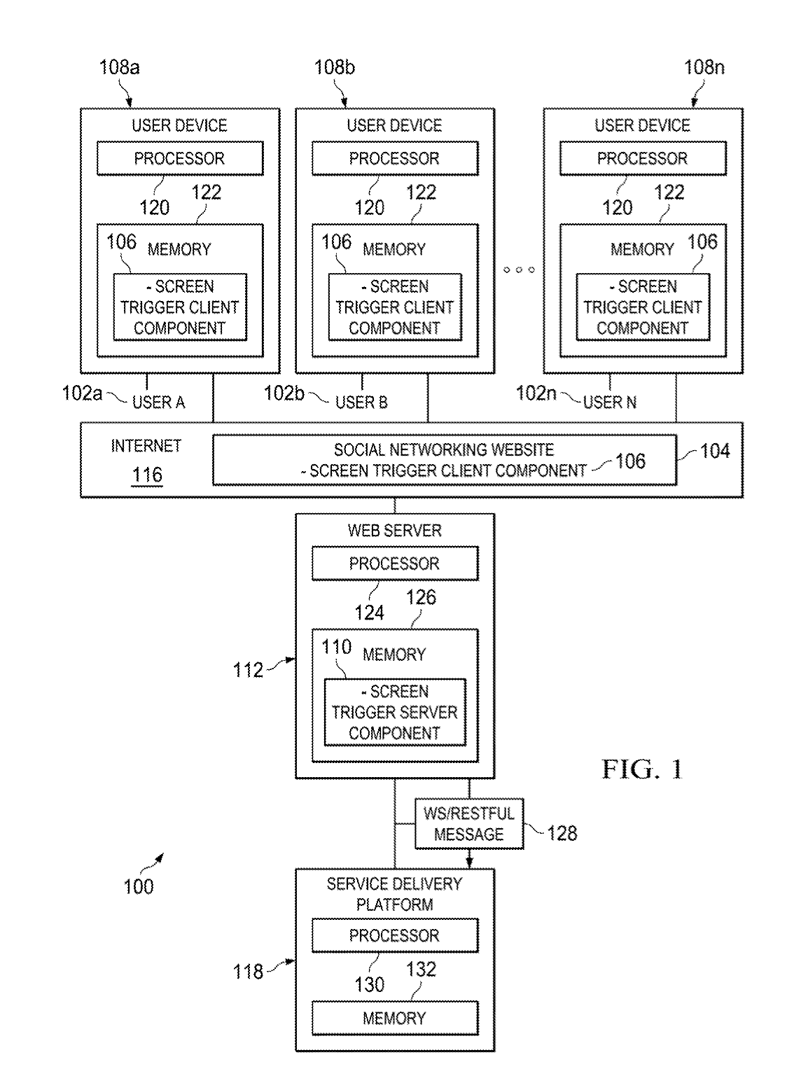

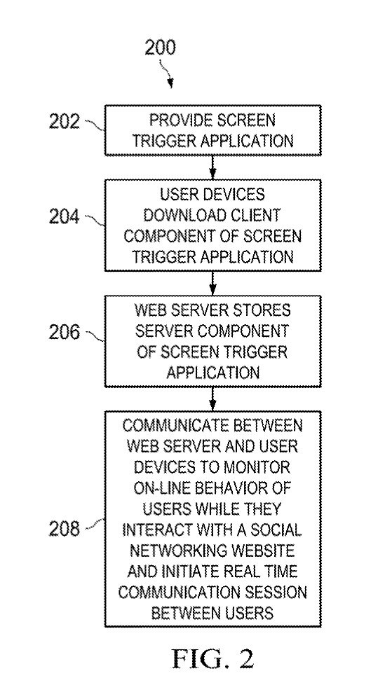

Referring to FIGS. 1 and 2, there are respectively shown a block diagram of an exemplary system 100 and a flowchart of a method 200 for allowing users 102a, 102b . . . 102n of a social networking web site 104 to engage in a real time communication session in accordance with an embodiment of the present invention. The exemplary system 100 and method 200 enable the users 102a, 102b . . . 102n (users A, B . . . N) of the social networking web site 104 to engage in a real time communication (e.g., voice, video and multimedia) by participating in a screen trigger application which has two components a client component 106 (located in user devices 108a, 108b . . . 108n) and a server component 110 (located in a web server 112). The screen trigger application's client component 106 and server component 110 effectively monitor the on-line behavior of the users 102a, 102b . . . 102n while they interact with the social networking web site 104 and when conditions which have been set by the users 102a, 102b . . . 102n have been met then the screen trigger application 106 and 110 initiates a real time communication session between one or more of the users 102a, 102b . . . 102n. As shown in FIG. 1, the system 100 includes the user devices 108a, 108b . . . 108n (e.g., laptop computer, desktop computer, smart phone, set top box) connected to the Internet 116 (including the social networking web site 104) which is also connected to the web server 112 (e.g., web 2.0 server 112). The web server 112 is also connected to a service delivery platform 118 (e.g., services integration gateway 118, Ericsson composition engine 118). A detailed discussion about how the user devices 108a, 108b . . . 108n, the web server 112 and the service delivery platform 118 are configured and used in the present invention follows:

1. The user devices 108a, 108b . . . 108n contain a processor 120, a non-transitory memory 122 (with processor-executable instructions), and the screen trigger application's client component 106 (screen trigger client widget 106). The users 102a, 102b . . . 102n download the screen trigger application's client 106 into their respective user devices 108a, 108b . . . 108n from the social networking web site 104. The users 102a, 102b . . . 102n can use the screen trigger application's client component 106 while he/she is logged into the social networking web site 104. The users 102a, 102b . . . 102n can be considered to be a group of users on the social networking web site 104.

2. The web server 112 interfaces with the users 102a, 102b . . . 102n (via the user devices 108a, 108b . . . 108n and the social networking web site 104) on one side and the service delivery platform 118 on the other side. As shown, the web server 112 includes a processor 124, a non-transitory memory 126 (with processor-executable instructions), and the screen trigger application's server component 110. The web server 112 implements the screen trigger application's server component 110 to collect and process the behavioral information of all the users 102a, 102b . . . 102n while they are at the social networking web site 104 over a specific period of time and when conditions which have been set by the users 102a, 102b . . . 102n have been met then the screen trigger application's server component 110 initiates a real time communication session (e.g., voice, video and multimedia) between one or more of the users 102a, 102b . . . 102n. When conditions are met to initiate the real time session, the web server 112 sends an appropriate WS (Web Services)/Restful message 128 to the service delivery platform 118. In effect, the web server 112 monitors the online status of all the users 102a, 102b . . . 102n and translates their ‘screen trigger’ behavior into WS/Restful messages 128. The web server 112 can be located either in a carrier's network or in an OTT service provider's network.

3. The service delivery platform 118 may also reside in the carrier's network or in an OTT service provider's network. In this application, the service delivery platform 118 includes a processor 130 and a non-transitory memory 132 (with processor-executable instructions) that function to translate the WS/Restful message 128 into telephony/network protocols. The service delivery platform 118 also provides service layer authentication for all subscribers (users 102a, 102b . . . 102n) and manages the service availability by ensuring the admission control (i.e., not allow any service or real time session that may choke the capacity of the service provider's network).

As shown in FIG. 2, the method 200 for allowing users 102a, 102b . . . 102n of the social networking web site 104 to engage in a real time communication session comprises the following steps: (a) providing the screen trigger application which includes the client component 106 and the server component 110 (step 202); (b) enabling users 102a, 102b . . . 102n to download into their user devices 108a, 108b . . . 108n the screen trigger application's client component 106 from the social networking web site 104 (step 204); (c) providing the screen trigger application's server component 110 to the web server 112 (step 206); and (d) enabling communications between the web server 112 and the user devices 108a, 108b . . . 108n which downloaded the screen trigger application's client component 106 to monitor the on-line behavior of the users 102a, 102b . . . 102n while they interact with the social networking web site 104 and when conditions which have been set by the users 102a, 102b . . . 102n have been met then initiate a real time communication session between one or more of the users 102a, 102b . . . 102n.

The following are a few examples of real time communication sessions that can be initiated by using the screen trigger application 106 and 110:
Telephony session
   Basic voice conversation
Content sharing
   Share photos, videos, files etc. online in real time
Video sessions
   Interactive video chat
Multimedia session
Any combination of the above in real time

And, now here are some examples of the screen trigger application 106 and 110:
Real time communication session can be initiated by combining on-screen events with the user profile preference stored at the social networking web sites 104 (Facebook, Myspace etc.)
   If ‘poked’ by friends ‘x’, ‘y’, and ‘z’, initiate a conference call.
   If friends ‘x’, ‘y’ and ‘z’ write on my ‘wall’, set up a video sharing conference session as soon as I read my ‘wall’.
   If application ‘a’, ‘b’ or ‘c’ is executed simultaneously by me and my friends ‘x’, ‘y’, and ‘z’, set up a multimedia conference session.
   Use photos from the social networking web site profile (or from the IM) for enhanced multimedia conference experience.
   Indicate participants, person who has the floor control etc. during the conference session.
Call center application for enhanced customer support.
   Initiate a telephony session, share document ‘x’, show video file ‘y’ etc., if user sends an email with question ‘a’, ‘b’ or ‘c’
Etc.

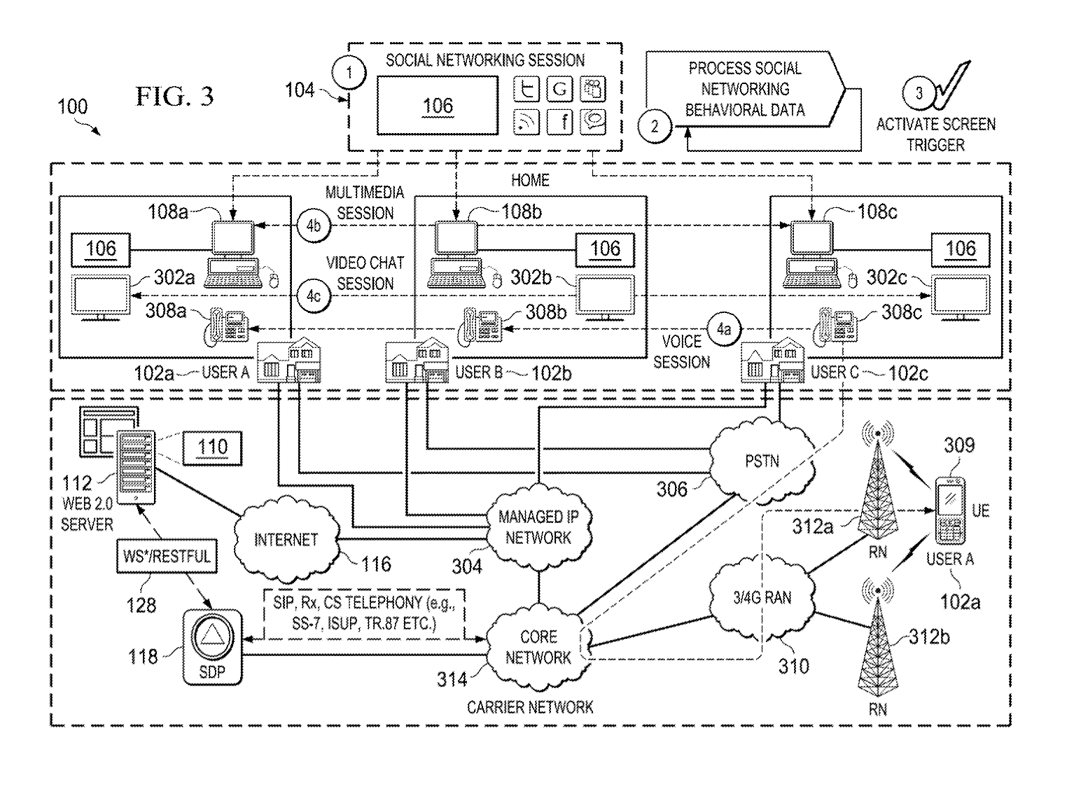

Referring to FIG. 3, there is a block diagram illustrating an architectural view of the exemplary system 100 in accordance with an embodiment of the present invention. As shown, users A, B and C (corresponding to users 102a, 102b and 102c) are subscribers of one or more social networking web sites 104. The users A, B and C all have a broadband connection for their user devices 108a, 108b and 108c (desktop computers 108a, 108b and 108c) and televisions 302a, 302b and 302c which is used for accessing the Internet 116 and IPTV services (via a managed IP network 304). The users A, B, and C also subscribe to regular telephone services via a PSTN 306 for their landline phones 308a, 308b and 308c. User A also owns a mobile device 309 which is serviced by a 3/4G RAN 310 and multiple RNs 312a and 312b. The architectural view also shows the interface (WS/restful 128) between the Web2.0 server 112 and the SDP 118 as well as the interface (e.g., SIP, Rx, CS telephony—SS-7, ISUP, TR.87 etc. . . . ) between the SDP 118 and a core network 314. As can be seen, the core network 314 is also connected to the managed IP network 304, the PSTN 306, and the 3/4G RAN 310. The following are the communication sessions shown in FIG. 3:

1. Users A, B and C are regular users of the social networking web site 104. They all have subscribed to the proposed screen trigger application. As described above, the screen trigger application includes two components 106 and 110. The screen trigger application's client component 106 is downloaded from the social networking web site 104 into and resides in the user's devices 108a, 108b, 108c such as, for example, a laptop, a desktop, STB (Set Top Box). In contrast, the screen trigger application's server component 110 resides in the Web 2.0 server 112. In operation, the Web 2.0 server 112 (i.e., the screen trigger application's server component 110) is updated each time there is a change in any ‘state’ associated with one of the screen trigger application's client components 106. Then, the Web 2.0 server 112 (i.e., the screen trigger application's server component 110) updates the screen trigger application's client components 106 of the other users who are part of the screen trigger application if that specific ‘state’ change requires to do so upon executing the business logic of the screen trigger application 106 and 110.

2. The screen trigger application 106 and 110 continues to process the data, i.e., the online behavior of the users A, B and C while they are at the social networking web site 104.

3. Once all of the conditions set by the users A, B and C are met, then the screen trigger application 106 and 110 initiates a real time communication session between the users A, B and C.

4. The following real time communication sessions can be established between the users A, B and C.
a. A basic conference call (voice session) is setup between all three users A, B and C. In this example, user A participates in this basic conference call by using his mobile device 309.
b. A multimedia session is setup between all three users A, B and C via their desktop computers 108a, 108b and 108c.
c. An interactive video session is setup between all three users A, B and C on their televisions 302a, 302b and 302c.

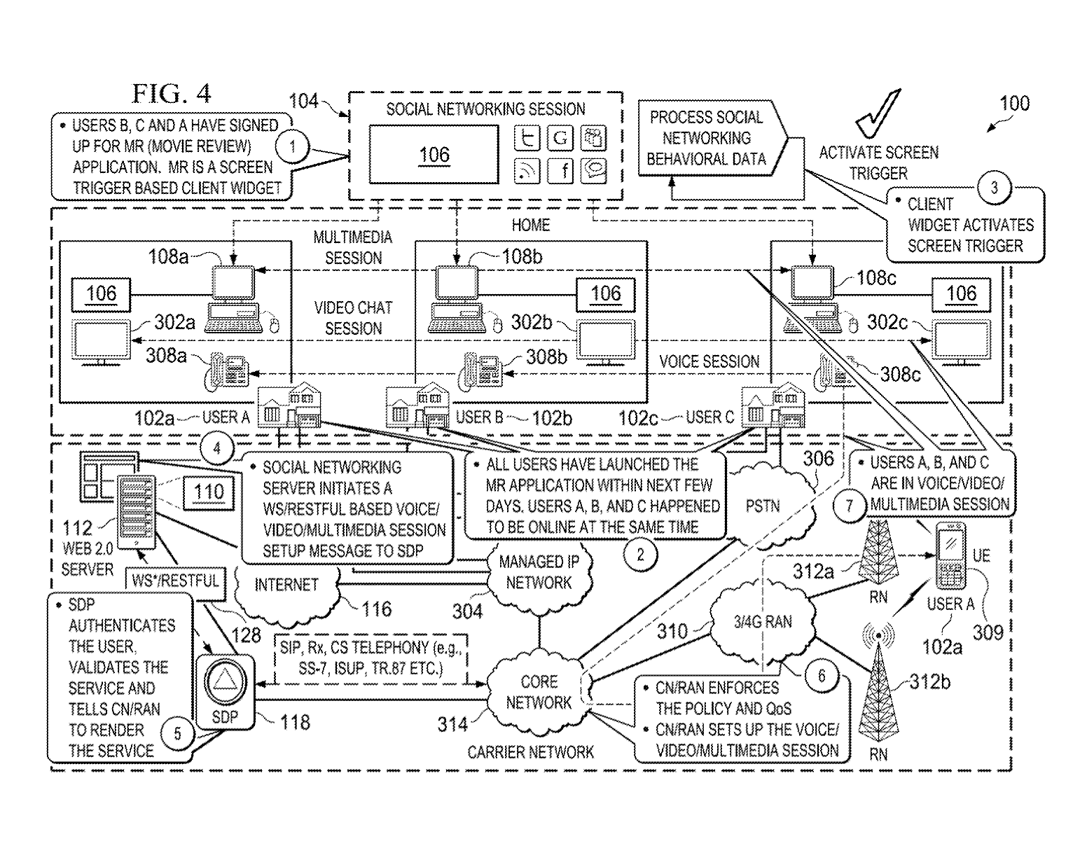

Referring to FIG. 4, there is a block diagram illustrating a high level sequence of events associated with the exemplary system 100 shown in FIG. 3 while implementing an exemplary movie review screen trigger application 106 and 110 in accordance with an embodiment of the present invention. As shown, users A, B and C (corresponding to users 102a, 102b and 102c) are subscribers of one or more social networking web sites 104. The users A, B and C all have a broadband connection for their user devices 108a, 108b and 108c (desktop computers 108a, 108b and 108c) and televisions 302a, 302b and 302c which is used for accessing the Internet 116 and IPTV services (via a managed IP network 304). The users A, B, and C also subscribe to regular telephone services via a PSTN 306 for their landline phones 308a, 308b and 308c. User A also owns a mobile device 309 which is serviced by a 3/4G RAN 310 and multiple RNs 312a and 312b. The architectural view also shows the interface (WS/restful 128) between the Web2.0 server 112 and the SDP 118 as well as the interface (e.g., SIP, Rx, CS telephony—SS-7, ISUP, TR.87 etc. . . . ) between the SDP 118 and a core network 314. As can be seen, the core network 314 is also connected to the managed IP network 304, the PSTN 306, and the 3/4G RAN 310. The following are the high level sequence of events associated with the exemplary movie review screen trigger application 106 and 110:

1. Users A, B and C sign up for and download the movie review screen trigger application's client component 106 from the social networking web site 104. The movie review screen trigger 106 and 110 may be provided by a telecommunication operator who will profit when the Users A, B and C take part in a real time communication session (e.g., voice, video and multimedia).

2. Over the next week or so all of the users A, B and C launch the movie review screen trigger's client component 106 and review the movie “Avatar”. The users A, B, and C also happen to be online with the social networking web site 104 at the same time one evening.

3. The Web 2.0 server 112 (i.e., movie review screen trigger application's server component 110) processes the information associated with the movie review screen trigger application of the users A, B and C. Since, the users A, B, and C all have reviewed the same movie over the last week and they all happen to be currently online with the social networking web site 104, the Web 2.0 server 112 initiates a real time communication session between users A, B and C.

4. The Web 2.0 server 112 reviews a movie review screen trigger application profile of each user A, B and C and finds out that all of these users A, B and C want real time voice, video, and multimedia sessions. Then, the Web 2.0 server 112 sends WS/Restful messages 128 to the SDP 118 for initiating voice, video, and multimedia sessions between users A, B and C.

5. The SDP 118 authenticates the users A, B and C and checks with the core network 314 to determine if there are enough resources available to support the real time voice, video, and multimedia sessions between users A, B and C. The SDP 118 also finds out that the user A's voice call needs to be setup at his/her mobile device 309. Once everything checks out, the SDP 118 sends telephony/network protocol messages to the core network 314 and the 3/4G RAN 310 for initiating voice, video, and multimedia sessions between users A, B and C.

6. The core network 314 and 3/4G RAN 310 checks the policy and provides the proper QoS over the various network elements. Then, the real time voice, video, and multimedia sessions are setup between users A, B and C.

7. Users A, B and C are now engaged in real time communication over voice, video, and multimedia sessions. The users A, B and C can talk about the movie “Avatar” some more, share some video clips of the movie, share some of their own video clips using high-end animation making tools, perform some video chat over their televisions 302a, 302b and 302c etc.

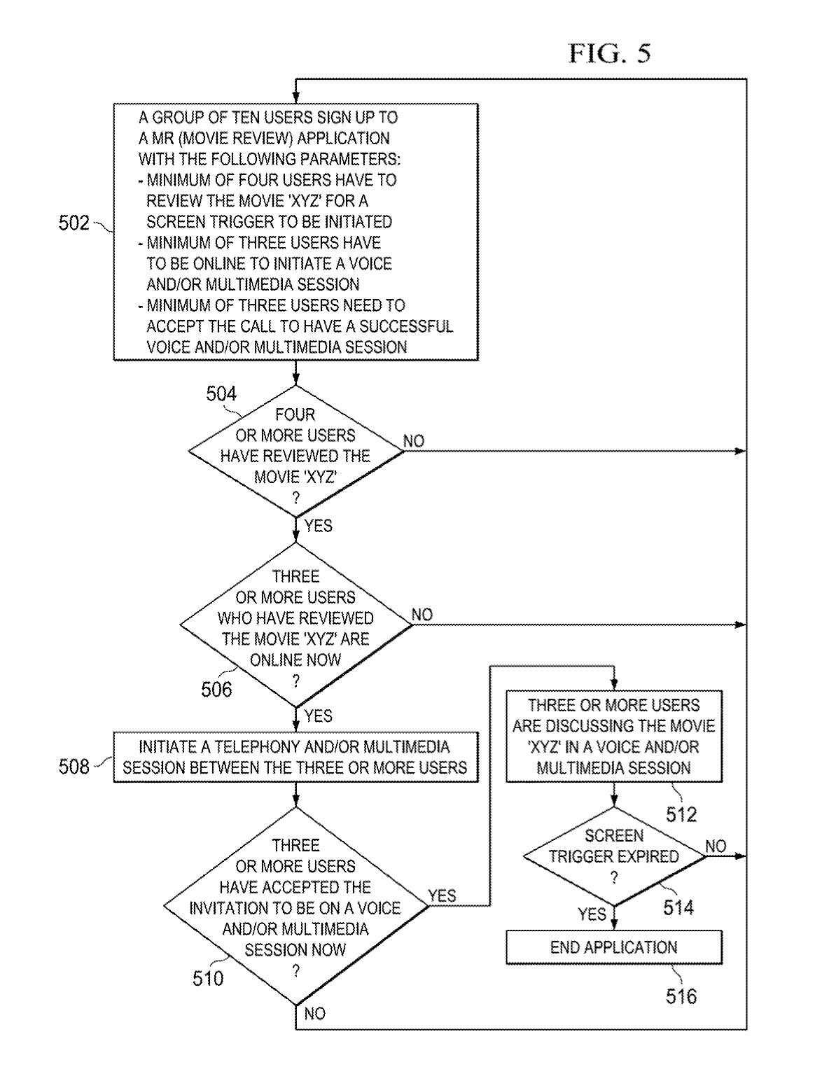

FIG. 5 provides further details about the exemplary movie review screen trigger application 106 and 110 described above. In particular, FIG. 5 illustrates the flow of events required to turn on the exemplary movie review screen trigger application 106 and 110. In step 502, a group of ten users 102a, 102b . . . 102j sign-up and download the movie review screen trigger application 106 and 110 which has the following parameters: (1) minimum of four users have to review the movie “Avatar” for the screen trigger to be initiated; (2) minimum of three uses have to be online with the social networking web site 104 to initiate a voice and/or multimedia session; and (3) minimum of three users need to accept the call to have a successful voice and/or multimedia session. At step 504, the movie review screen trigger application 106 and 110 determines if four or more users have reviewed the movie “Avatar”. If the result of step 504 is no, then return to step 502. If the result of step 504 is yes, then the movie review screen trigger application 106 and 110 determines at step 506 if three or more users who have reviewed the movie “Avatar” are currently online with the social networking web site 104. If the result of step 506 is no, then return to step 502. If the result of step 506 is yes, then the movie review screen trigger application 106 and 110 initiates at step 508 a voice and/or multimedia session between the three or more users. At step 510, the movie review screen trigger application 106 and 110 determines if the three or more uses have accepted the invitation to be on a voice and/or multimedia session. If the result of step 510 is no, then return to step 502. If the result of step 510 is yes, then at step 512 the three or more users discuss the movie “Avatar” in the voice and/or multimedia session. At step 514, the movie review screen trigger application 106 and 110 determines if the screen trigger has expired. If the result of step 514 is no, then return to step 502. If the result of step 514 is yes, then end the movie review screen trigger application 106 and 110.

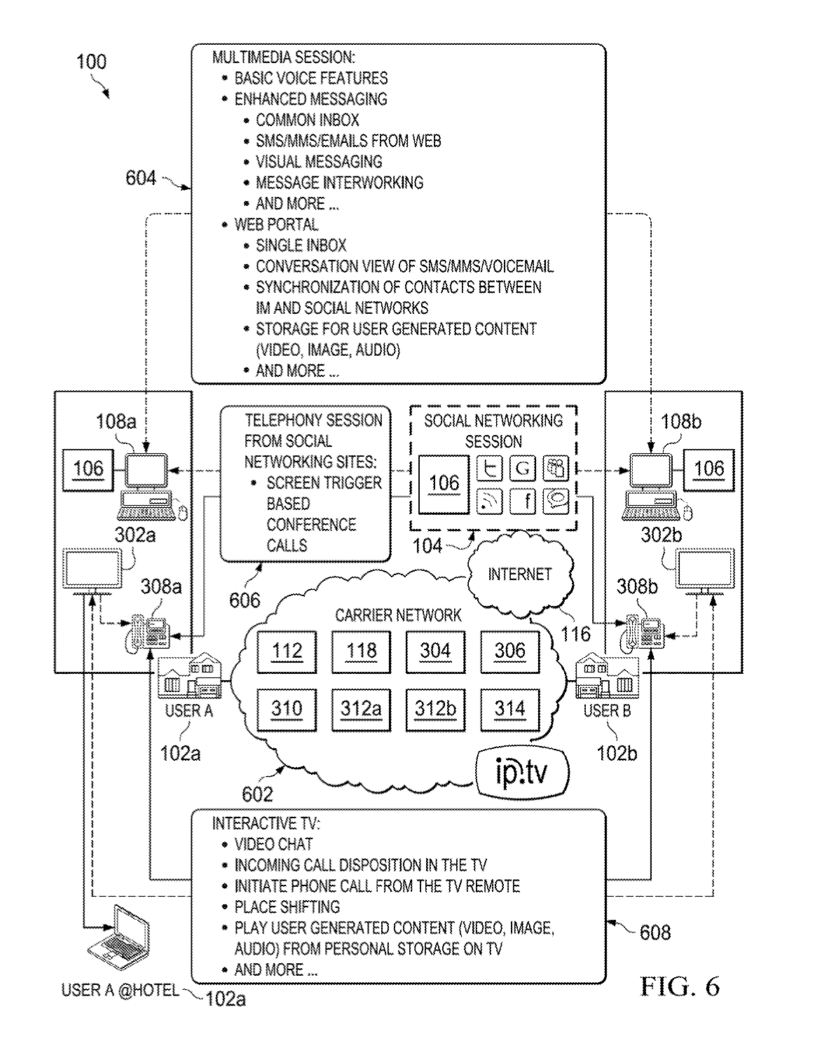

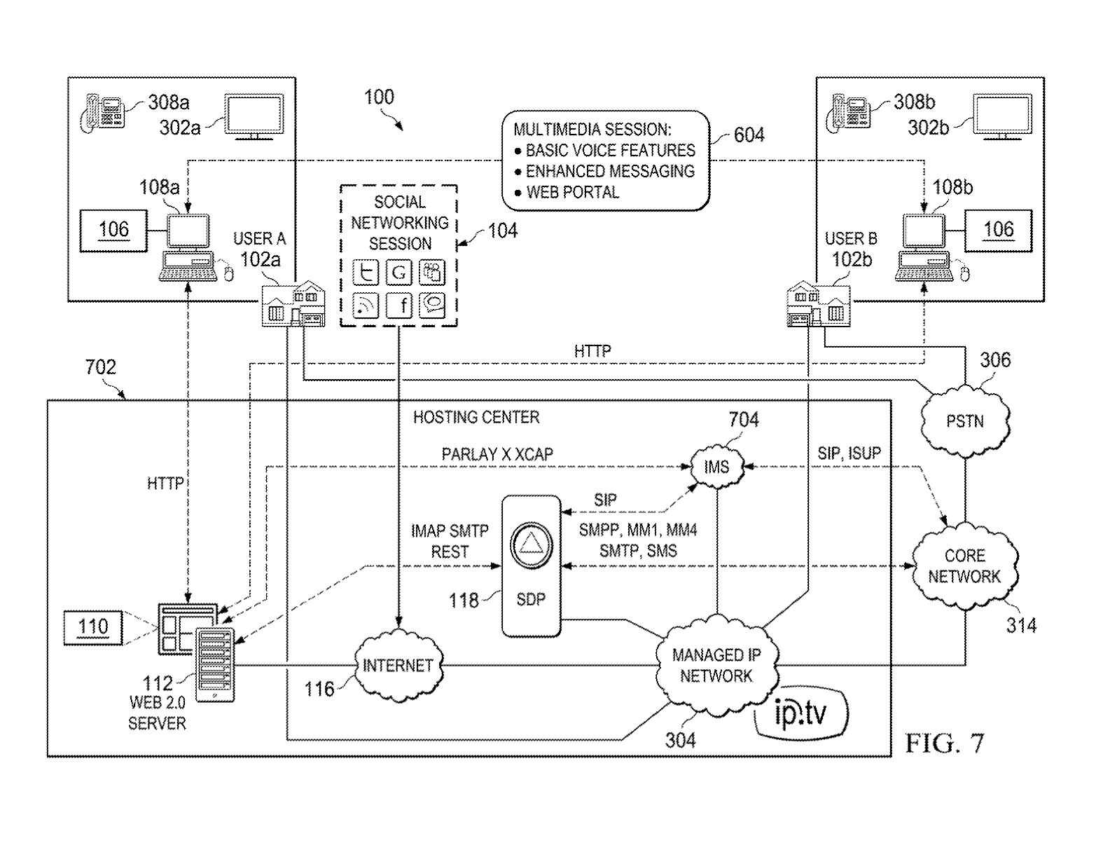

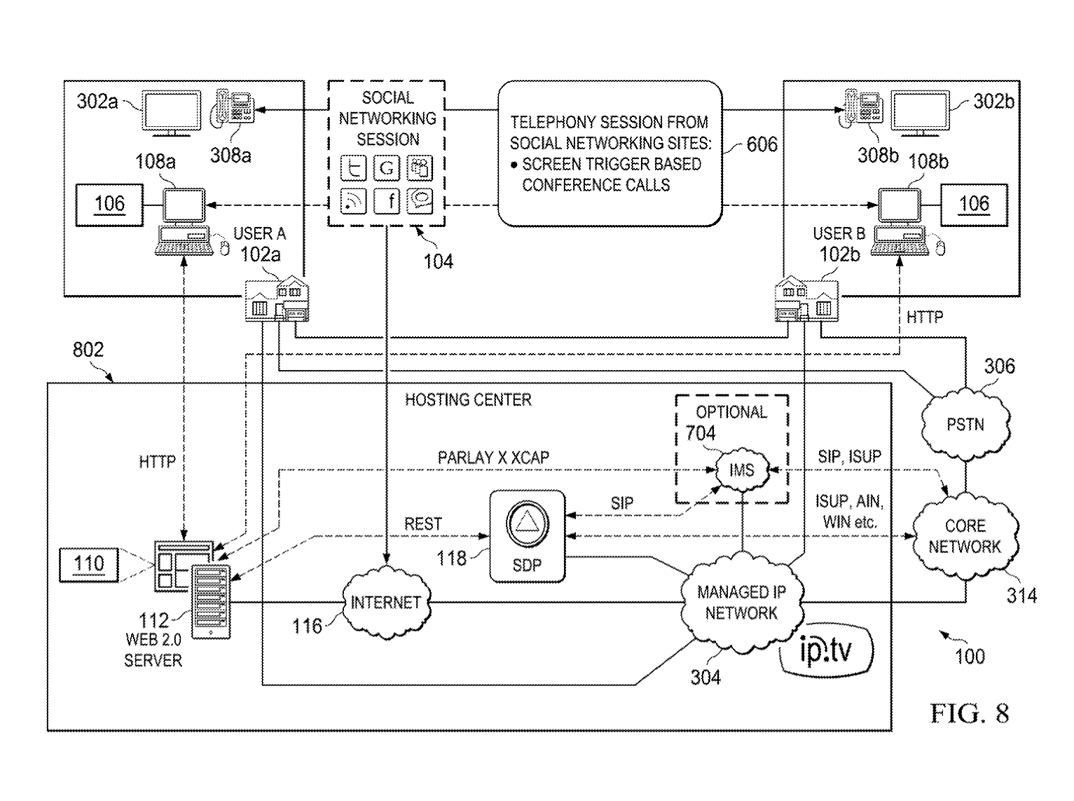

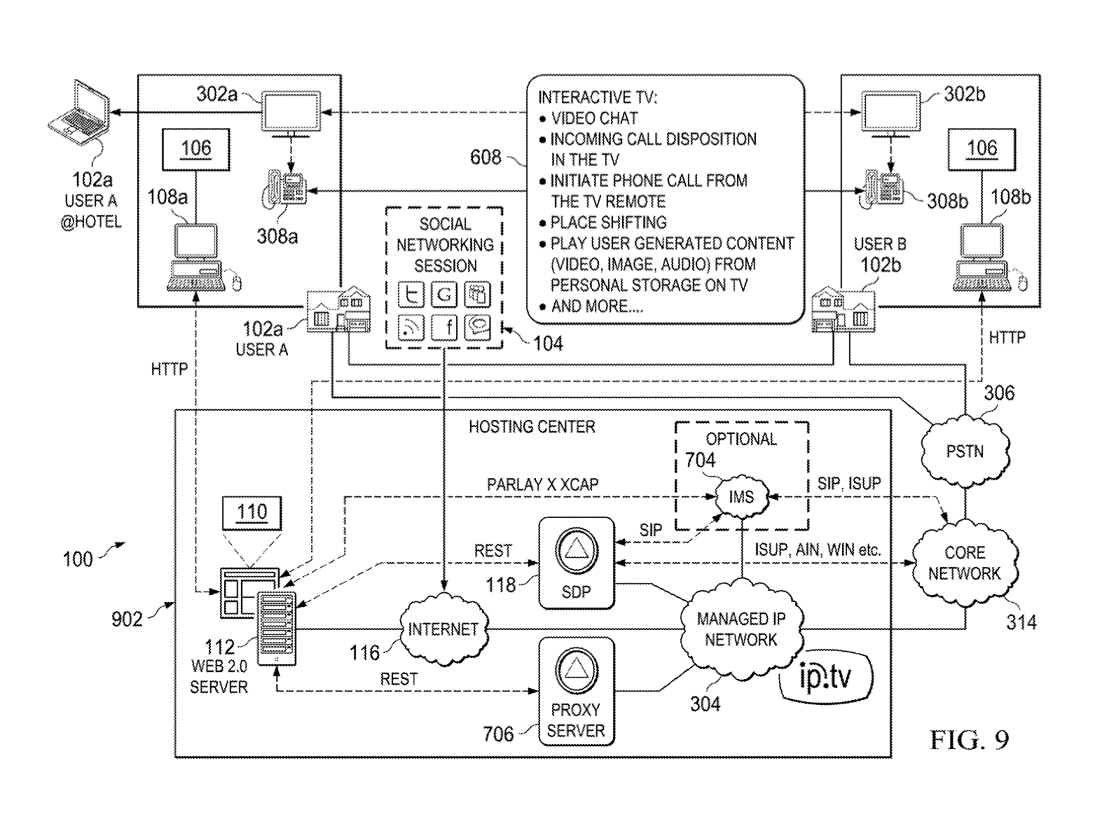

Referring to FIG. 6, there is shown a diagram that illustrates the different types of real time communication sessions that can be established between users A and B (only two shown) in accordance with an embodiment of the present invention. In this example, the users A and B (only two shown) are connected by the carrier network 602 which can include the Web 2.0 server 112, the Internet 116, the SDP 118, the managed IP network 304, the PSTN 306, the 3/4G RAN 310, the RNs 312a and 312b, and the core network 314 (see FIG. 3). In particular, the users A and B can user their computers 108a and 108b to take part in a multimedia session 604 including basic voice features, enhanced messaging and web portal (see FIG. 7). Alternatively, the users A and B can use their landline phones 308a and 308b to take part in a telephony session 606 (see FIG. 8). Or, the users A and B can use their televisions/computers 302a and 302b and their landline phones 308a and 308b to take part in an interactive TV session 608 (see FIG. 9). Exemplary architectures that can be used to enable the multimedia session 604, the telephony session 606, and the interactive TV session 608 between users A and B are described in detail next with respect to FIGS. 7-9.

Referring to FIG. 7, there is a block diagram illustrating an architectural view of the exemplary system 100 when two users A and B take part in the multimedia session 604 in accordance with an embodiment of the present invention. As shown, users A and B (only two shown) are subscribers of one or more social networking web sites 104. The users A and B each have a broadband connection for their user devices 108a and 108b (desktop computers 108a and 108b) and televisions 302a and 302b which is used for accessing the Internet 116 and IPTV services (via the managed IP network 304). The users A and B also subscribe to regular telephone services via the PSTN 306 for their landline phones 308a and 308b. The PSTN 306 is connected to the core network 314. The architectural view also shows a hosting center 702 that includes the Web 2.0 server 112, the SDP 118, the Internet 116, the managed IP network 304, and an IMS 704. The managed IP network 304 is connected to the IMS 704. As shown, the desktop computers 108a and 108b have HTTP interfaces to the Web 2.0 server 112. The Web 2.0 server 112 is connected via the Internet 116 to the managed IP network 304. Furthermore, the Web 2.0 server 112 has a ParlayX/XCAP interface to the IMS 704 and an IMAP/SMTP/REST interface to the SDP 118. The SDP 118 has a SIP interface to the IMS 704 and an SMPP/MM1/MM4/SMTP/SMS interface to the core network 314. The IMS 704 has an SIP/ISUP interface to the core network 314.

Referring to FIG. 8, there is a block diagram illustrating an architectural view of the exemplary system 100 when two users A and B take part in the telephony session 606 in accordance with an embodiment of the present invention. As shown, users A and B (only two shown) are subscribers of one or more social networking web sites 104. The users A and B each have a broadband connection for their user devices 108a and 108b (desktop computers 108a and 108b) and televisions 302a and 302b which is used for accessing the Internet 116 and IPTV services (via the managed IP network 304). The users A and B also subscribe to regular telephone services via the PSTN 306 for their landline phones 308a and 308b. The PSTN 306 is connected to the core network 314. The architectural view also shows a hosting center 802 that includes the Web 2.0 server 112, the SDP 118, the Internet 116, the managed IP network 304, and an IMS 704 (optional). The managed IP network 304 is connected to the IMS 704. As shown, the desktop computers 108a and 108b have HTTP interfaces to the Web 2.0 server 112. The Web 2.0 server 112 is connected via the Internet 116 to the managed IP network 304. Furthermore, the Web 2.0 server 112 has a ParlayX/XCAP interface to the IMS 704 and a REST interface to the SDP 118. The SDP 118 has a SIP interface to the IMS 704 and an ISUP/AIN/WIN interface to the core network 314. The IMS 704 has an SIP/ISUP interface to the core network 314.

Referring to FIG. 9, there is a block diagram illustrating an architectural view of the exemplary system 100 when two users A and B take part in the interactive TV session 608 in accordance with an embodiment of the present invention. As shown, users A and B (only two shown) are subscribers of one or more social networking web sites 104. The users A and B each have a broadband connection for their user devices 108a and 108b (desktop computers 108a and 108b) and televisions 302a and 302b which is used for accessing the Internet 116 and IPTV services (via the managed IP network 304). The users A and B also subscribe to regular telephone services via the PSTN 306 for their landline phones 308a and 308b. The PSTN 306 is connected to the core network 314. The architectural view also shows a hosting center 902 that includes the Web 2.0 server 112, the SDP 118, the Internet 116, the managed IP network 304, an IMS 704 (optional), and a proxy server 706. The managed IP network 304 is connected to the IMS 704 and the proxy server 706. As shown, the desktop computers 108a and 108b have HTTP interfaces to the Web 2.0 server 112. The Web 2.0 server 112 is connected via the Internet 116 to the managed IP network 304. Furthermore, the Web 2.0 server 112 has a ParlayX/XCAP interface to the IMS 704 and REST interfaces to the SDP 118 and the proxy server 706. The SDP 118 has a SIP interface to the IMS 704 and an ISUP/AIN/WIN interface to the core network 314. The IMS 704 has an SIP/ISUP interface to the core network 314.

From the foregoing, one skilled in the art will appreciate that the present invention is aimed, at least, to provide a system 100 and method 200 for allowing the users 102a, 102b . . . 102n of the social networking web site 104 to engage in a real time communication (e.g., voice, video and multimedia) by participating in a ‘screen trigger’ application. The ‘screen trigger’ application accumulates a group's (all of whom are users 102a, 102b . . . 102n of the social networking web site 104) behavior and initiates the real time communication session upon fulfillment of conditions selected by the group members 102a, 102b . . . 102n. Thus, the present invention effectively enables telecommunication operators to profit when the social networking users 102a, 102b . . . 102n utilize the telecommunication network components (e.g., the telephone, IP/Cable TV, wireless phone and computer) when they take part in the real time communication session. This is done in part by deploying sophisticated ‘screen trigger’ applications at the social networking web site 104 and the web server 112. The following are some of the main advantages of the present invention:
The present invention allows the telecommunications operators to tap into the huge revenue potential opened up by the large subscriber base of the social networking users. In particular, the present invention will put the telecommunications operators into the value chain of online advertising, application business etc.
The present invention enables the telecommunications operators to monetize their other network assets such as location, subscriber profile, device type etc.
By integrating real time communication with the social networking activities, the users 102a, 102b . . . 102n can enjoy the following benefits:
   Link their social networking web site ID with their phone numbers.
   Establish a real time communication with their friend, family or choice of business according to the conditions set by them.
   Have a better user experience while engaged in multimedia sessions with call center employees for solving a specific problem (e.g., watch a video for fixing the pump in real time).
The present invention is also a win-win proposition for OTT service providers. By enabling real time communications from their social networking web sites 104 they stand to create “stickiness” for their existing subscriber base. This will reduce subscriber churn while encouraging further growth.

One skilled in the art will readily appreciate that the user devices 108a, 108b . . . 108n, the web server 112, the service delivery platform 118, and other devices shown and described herein omit many components which are not needed to explain how they function to allow the users 102a, 102b . . . 102n of the social networking web site 104 to engage in a real time communication session in accordance with an embodiment of the present invention.

In another aspect, the present invention includes a computer program product (screen trigger application 106 and 110) comprising computer readable code which is stored in one or more non-transitory memories 122 and 126 (within user devices 108a, 108b . . . 108n and web server 112) and when run in one or more computers 120 and 124 (within user devices 108a, 108b . . . 108n and web server 112) causes the computers 120 and 124 to perform the following: (a) monitor on-line behavior of users 102a, 102b . . . 102n while they interact with the social networking web site 104 and when conditions which have been set by the users 102a, 102b . . . 102n have been met then initiate a real time communication session between one or more of the users 102a, 102b . . . 102n. The computer program has an advantage in that it can enable a telecommunication operator to profit from users 102a, 102b . . . 102n interfacing with the social networking web sites 104.

Although one embodiment of the present invention has been illustrated in the accompanying Drawings and described in the foregoing Detailed Description, it should be understood that the invention is not limited to the disclosed embodiment, but instead is also capable of numerous rearrangements, modifications and substitutions without departing from the present invention that as has been set forth and defined within the following claims.

1. A method for allowing users of a social networking web site to engage in a real time communication session, the method comprising the steps of:
providing a screen trigger application having a client component and a server component;
enabling users to download into user devices the client component of the screen trigger application from the social networking web site;
providing the server component of the screen trigger application to a web server; and
enabling communications between the web server and the user devices which downloaded the client component to monitor on-line behavior of the users while the users interact with the social networking web site and when conditions which have been set by the users have been met then initiate a real time communication session between one or more of the users.

2. The method of claim 1, wherein the step of enabling communications between the web server and the user devices further comprises the steps of:
sending an update to the server component in the web server each time there is on-line behavior of one of the users that changes a state associated with the client component in one of the user devices;
sending an update or a real time communication session request to the client component in the other user devices if the update sent to the server component in the web server from the one user device satisfies one or more conditions within the server component in the web server; and
sending a real time communication session request to the client component in the one user device if required by one or more conditions in the server component in the web server.

3. The method of claim 1, wherein the real time communication session is one of a conference call, a multimedia session, or an interactive video session.

4. The method of claim 1, further comprising the step of enabling the web server to send a message to a service delivery platform residing in a communications network to establish the real time communication session when the one or more conditions are satisfied to initiate the real time communication session.

5. The method of claim 4, further comprising the step of enabling the service delivery platform to authenticate the users devices and check with a core network to determine if enough resources are available to establish the real time communication session between the one or more users.

6. The method of claim 5, further comprising the step of enabling the service delivery platform to send messages to the core network to establish the real time communication session between the one or more users.

7. The method of claim 6, further comprising the step of enabling the core network to check policy and provide a predetermined quality of service over network elements to setup the real time communication session between the one or more users.

8. A user device that allows a user of a social networking web site to engage in a real time communication session with other users that also interact with the social networking web site, the user device comprising:
a processor; and
a non-transitory memory that stores processor-executable instructions wherein the processor interfaces with the non-transitory memory and executes the processor-executable instructions to:
download a client component of a screen trigger application from the social networking web site; and
communicate with a web server that implements a server component of the screen trigger application to:
send an update to the server component in the web server each time there is an on-line behavior of the user that changes a state associated with the client component of the screen trigger application;
receive an update from the server component in the web server to monitor on-line behavior of the other users while at the social networking web site; and
receive a real time communication session request from the server component in the web server when conditions which have been set by the user and the other users have been met to initiate the real time communication session between the user and the other users.

9. A method implemented by a user device for allowing a user of a social networking web site to engage in a real time communication session with other users that also interact with the social networking web site, the method comprising the steps of:
downloading a client component of a screen trigger application from the social networking web site; and
communicating with a web server that implements a server component of the screen trigger application, wherein the communicating step further comprises:
sending an update to the server component in the web server each time there is an on-line behavior of the user that changes a state associated with the client component of the screen trigger application;
receiving an update from the server component in the web server to monitor on-line behavior of the other users while at the social networking web site; and
receiving a real time communication session request from the server component in the web server when conditions which have been set by the user and the other users have been met to initiate the real time communication session between the user and the other users.

10. A web server that allows users of a social networking web site to engage in a real time communication session, the web server comprising:
a processor; and
a non-transitory memory that stores processor-executable instructions wherein the processor interfaces with the non-transitory memory and executes the processor-executable instructions to:
download a server component of a screen trigger application; and
communicate with user devices of the users that downloaded a client component of the screen trigger application from the social networking web site to:
receive an update from one of the client components in the user devices when there is an on-line behavior of the corresponding one of the users that changes a state associated with the corresponding client component of the screen trigger application;
send an update to the other ones of the client components in the user devices so the corresponding other users are able to monitor the on-line behavior of the one user while at the social networking web site; and
send a real time communication session request to the client components in the user devices when conditions which have been set by the users have been met to initiate the real time communication session between the users.

11. A method implemented by a web server for allowing users of a social networking web site to engage in a real time communication session, the method comprising the steps of:
downloading a server component of a screen trigger application; and
communicating with user devices of the users that downloaded a client component of the screen trigger application from the social networking web site, wherein the communicating step comprises:
receiving an update from one of the client components in the user devices when there is an on-line behavior of the corresponding one of the users that changes a state associated with the corresponding client component of the screen trigger application;
sending an update to the other ones of the client components in the user devices so the corresponding other users are able to monitor the on-line behavior of the one user while at the social networking web site; and
sending a real time communication session request to the client components in the user devices when conditions which have been set by the users have been met to initiate the real time communication session between the users.

12. A service delivery platform that interacts with a web server and a core network to allow users of a social networking web site to engage in a real time communication session, the service delivery platform comprising:
a processor; and
a non-transitory memory that stores processor-executable instructions wherein the processor interfaces with the non-transitory memory and executes the processor-executable instructions to:
receive a message from the web server to establish the real time communication session after the web server which implements a server component of a screen triggering application communicates with user devices which implement a client component of the screen trigger application that was downloaded from the social networking web site such that on-line behavior of the users of the user devices while the users interact with the social networking web site is monitored and when conditions which have been set by the users have been met then the web server initiates the message to establish the real time communication session between one or more of the users;
authenticate the users devices and check with the core network to determine if enough resources are available to establish the real time communication session between the one or more users; and
send messages to the core network to establish the real time communication session between the one or more users.

13. A method implemented by service delivery platform that interacts with a web server and a core network to allow users of a social networking web site to engage in a real time communication session, the method comprising the steps of:
receiving a message from the web server to establish the real time communication session after the web server which implements a server component of a screen triggering application communicates with user devices which implement a client component of the screen trigger application that was downloaded from the social networking web site such that on-line behavior of the users of the user devices while the users interact with the social networking web site is monitored and when conditions which have been set by the users have been met then the web server initiates the message to establish the real time communication session between one or more of the users;
authenticating the users devices and check with the core network to determine if enough resources are available to establish the real time communication session between the one or more users; and
sending messages to the core network to establish the real time communication session between the one or more users.

14. A system for allowing users of a social networking web site to engage in a real time communication session, the system comprising:
a plurality of user devices, each user device downloaded a client component of a screen trigger application from the social networking web site;
a web server that has stored therein a server component of the screen trigger application;
the user devices and the web server communicate to monitor on-line behavior of users of the user devices while the users interact with the social networking web site and when conditions which have been set by the users have been met then initiate a real time to communication session between the users; and
a service delivery platform that receives a message from the web server to establish the real time communication session between the users, authenticates the users devices, checks to determine if enough resources are available to establish the real time communication session between the users, and sends messages to establish the real time communication session between the users.
